(19) United States
(12) Patent Application Publication
(10) Pub. No.: US 2002/0059294 A1
(43) Pub. Date: May 16, 2002

(54) METHOD AND APPARATUS FOR ELABORATING AND REPRESENTING DATA ANALYSIS IN A DECISION SUPPORT SYSTEM

(76) Inventors: SANDRO BOTTARELLI, LUGANO (IT); ROCCO PELLEGRINELLI, RUVIGLIANA (IT); LUCA SPAMPINATO, VIA ETNAH-MILANO (IT)

Correspondence Address: SUGHRUE MION ZINN MACPEAK & SEAS, SUITE 800, 2100 PENNSYLVANIA AVENUE NW, WASHINGTON, DC, 200373202

(21) Appl. No.: 09/016,313

(22) Filed: Jan. 30, 1998

(51) Int. Cl. G06F 7/00; G06F 17/00

(52) U.S. Cl. 707/104.1

(57) ABSTRACT

The invention relates to a method and to an apparatus for elaborating and representing data analysis in a decision support system, the system comprising: an electronic data base which is daily updated; a data server managing said data base and comprising linking interfaces to allow on line and/or batch connections to external data suppliers or providers; display means for displaying information and data and for allowing to the user to define data selection criteria;

the method including the following steps:

presenting on said display means a selection panel or menu reporting a list or table of data from said data base;

detecting a pointer of a user's data selection;

scanning said data base according to a mask or filter selected by the user;

presenting on said display means a view or history chart showing to the user the variations versus time of the selected data, while maintaining the selection panel as a side or background view;

automatically and immediately refreshing said view or history chart at each different detected pointer of the user's data selection. Advantageously, a plurality of different information data may be selected one after the other through said selection panel and a corresponding plurality of history charts are shown on said display means with the same time base and in an overlapping format.

### TECHNICAL FIELD

The present invention relates to a method and apparatus for representing data analysis in a decision support system.

More specifically the invention relates to a method for elaborating and representing data analysis in a decision support system, the system comprising:

an electronic data base which is daily updated;

a data server managing said data base and comprising linking interfaces to allow on line and/or batch connections to external data suppliers or providers;

display means for displaying information and data and for allowing to the user to define data selection criteria.

The invention will be hereinafter illustrated with specific reference to the application field of investment strategies and portfolio/asset management. However, this field of application must be intended as an indicative and non-limiting example just to simplify the following description.

### BACKGROUND ART

As is well known, the process of evaluating huge amounts of daily changing data and information is hard, difficult and time consuming.

This is generally true in many application field, but it's even more fatiguing in financial activities such as the portfolio/asset management.

In this specific technical field huge amounts of information are daily available through usual specialized channels and expert managers spend their working time to evaluate, compare and decide the best investment opportunities.

As a matter of fact, the daily challenge of a professional portfolio manager is just that of spotting the right investment opportunities, reacting quickly to market changes while increasing the quality of the results.

This kind of activity is in the hands of expert professionals who offer their knowledge and capability to investors seeking the best investment opportunities. However, no one can assure that the chosen securities are really the best or are totally in line with the customers and investors expectations and criteria.

Good results are sometime obtained for casual reasons and don't necessary correspond to the efforts of the expert professional. Moreover, the evaluation activity is so time consuming to discourage deep analysis of huge amounts of data and information, thereby loosing some good investments possibilities.

Prior art solutions have already been proposed to support the expert professional in his or her decision process.

Those prior solutions consists in electronic data bases, which contain the historical data of a number of main securities which are daily updated by specialized agencies or providers, and so-called electronic sheets, such as the well konwn software package MS® Excel, to display the data.

The data are displayed by software tools which allow the professional user to watch the current numerical value of many securities and to compare such a current numerical value with past values series.

Those solutions are not totally satisfactory for a number of reasons:

the evaluation of the data is left to the expert users;

a comparison or integration between the data contained in different data bases is not always immediately available;

moreover, a comparison of historical series of data for different securities is available only after hard and time-consuming computing;

the data representation of the currently available software tools doesn't allow to check quickly different historical series;

the whole information set is difficult to manage and to evaluate so that a decision based on the available information is not taken according to the individual risk profile of the investor or to investment objectives.

A first object of the present invention is that of providing a new method of representing data analysis which may help the user to take faster decisions.

A further object of the present invention is to provide an innovative system which allows full personalization of investment strategies using a large range of indicators.

Another object of the present invention is that of providing a software tool which may be used by non-expert users.

A further object of the present invention is that of representing information data in a friendly user manner in order to facilitate the taking of a decision according to the individual risk profile of the investor and/or investment objectives.

A further object of the present invention is that of providing a easy-to-use interface which might help the user to work faster in taking all relevant investment decisions improving the results and reducing the risk of wrong decisions.

### SUMMARY OF THE INVENTION

The solution idea on which the invention is based is that of providing a fast reactive computer program interface which allows the user to quickly scan the data base through graphical images or views corresponding to historical paths of selected data.

According to this solution idea, the technical problem is solved by a method for elaborating and representing data analysis in a decision support system, the system comprising:

an electronic data base which is daily updated;

a data server managing said data base and comprising linking interfaces to allow on line and/or batch connections to external data suppliers or providers;

display means for displaying information and data and for allowing to the user to define data selection criteria;

the method including the following steps:

presenting on said display means a selection panel or menu reporting a list or table of data from said data base;

detecting a pointer of a user's data selection;

scanning said data base according to a mask or filter corresponding to the selection choosen by the user;

presenting on said display means a view or history chart showing to the user the variations versus time of the selected data, while maintaining a selected panel as a side or background view;

refreshing immediately said view or history chart at each different detected pointer of the user's data selection.

In this manner it's possible to quickly scan the securities in a portfolio flipping though detailed data and historical graphs.

Moreover, a plurality of different information data may be selected one after the other through said selection panel and a corresponding plurality of history charts are automatically shown in an overlapping format on said display means and with the same time base.

The feature and advantages of inventive method and apparatus will appear from the following non-limiting description of a preferred embodiment given by way of example with reference to the annexed drawings.

### BRIEF DESCRIPTION OF THE DRAWINGS

FIG. 1 shows a schematic diagram of an apparatus to implement the method according to the present invention;

FIG. 2 is an exemplary visual representation of a selection menu presented on a dislay according to the method of the present invention;

FIG. 3 is an exemplary visual representation of a selection panel according to the present invention;

FIG. 3A is a further exemplary visual representation of the selection panel according to the present invention;

FIG. 4 shows a schematic view of a historical data path of a selected data contained in a data base of the apparatus according to the present invention;

FIG. 5 is a further exemplary visual representation of a selection panel according to the present invention;

FIG. 6 shows a schematic view of a historical data path of a selected data shown in FIG. 5;

FIGS. 7 and 8 show respective overlapping historical data paths of a set of data contained in a data base of the present invention;

FIG. 9 is an exemplary visual representation of a graphic interface of the present invention;

FIG. 10 is an exemplary visual representation of a further graphic interface of the present invention;

FIG. 11 is a high level flow-chart representing the steps of a method in accordance with the present invention.

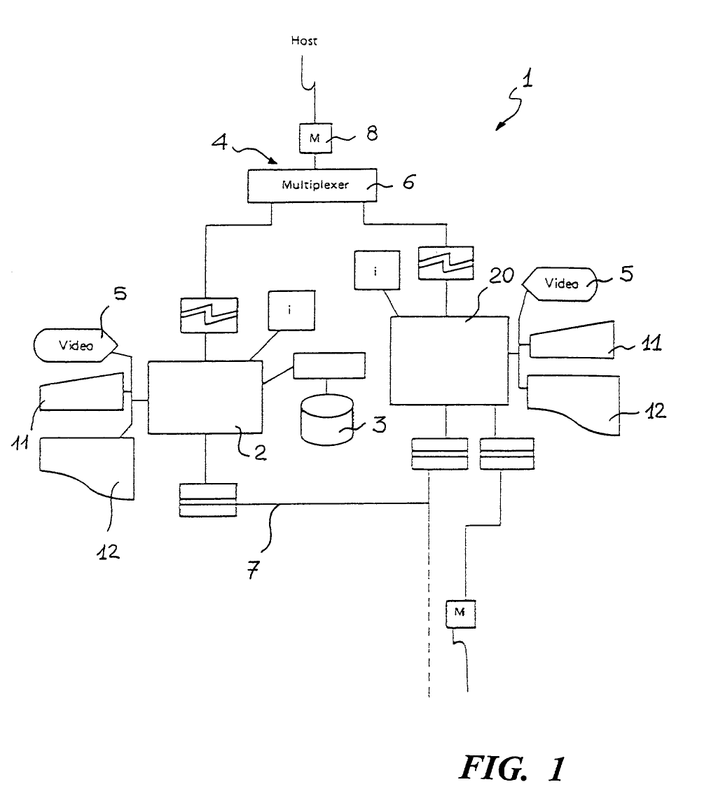

### DETAILED DESCRIPTION

1. Overview

In accordance with the present invention, a method and an apparatus is provided for elaborating and representing data analysis in a decision support system.

The method and the apparatus allows to combine:

fundamental information analysis;

statistical information analysis; and,

technical information analysis;

in order to integrate as many analytical tools are needed and give a specific weight to each indicator according to investor's individual risk profiles or investment objectives.

The inventive method and apparatus are implemented in a decision support system 1 including a computers local area network LAN 7 and an electronic data server 2.

The data server 2 comprises memory means 3 and linking interfaces 4, such a multiplexer 6 and a modem 8, and to allow on line and/or batch connections to external data suppliers or providers.

Video display means 5 are provided for displaying to the user information and data. A conventional keyboard 11 is associated to each computer 20 and network printer 12 is available too.

The memory means 3 are provided to store an independent database of financial information such as investment portfolios. In the specific example herein given by way of non-limiting illustration, the database contains asset and financial information including more than 3,000 instruments, 120 indexes and 50 currencies.

Each computer 20 which is connected on the LAN 7 contains a computer program according to the present invention and which is structured in a set of integrated easy-to-use software modules or subroutines which have been developed in a C++ programming language, within a Visual C++ MS® programming environment.

Each module interactively assists the user in performing a specific task, such as:

securities selection;

portfolio allocation and optimization;

portfolio analysis;

benchmark comparison; etc . . .

The user may combine the modules according to his favorite work flow as will be explained in the following description.

The modules interact by means of the portfolio data base. As soon as a portfolio data is modified by a module, all the other modules which are active on any computer of the LAN 7 are automatically alerted and the new state can be loaded.

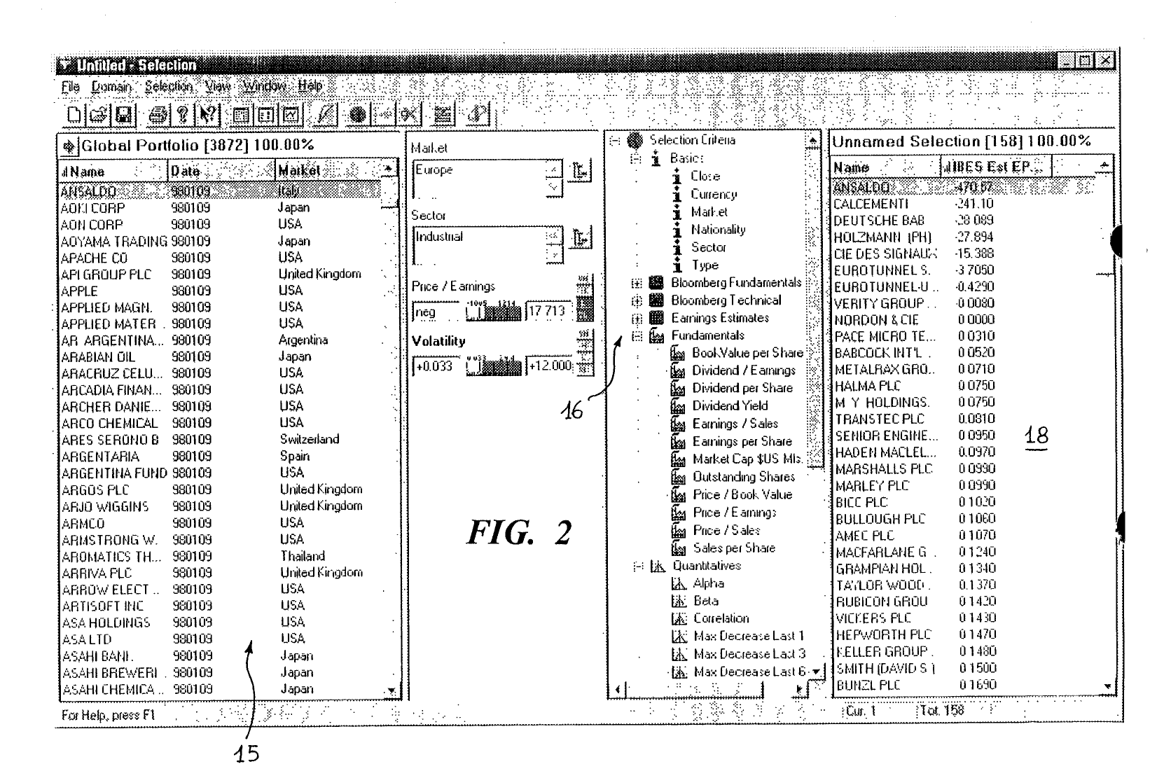

A portfolio is always presented as a browser with the list 15 of securities presented in a table, as shown in FIG. 2. The user can quickly configure the table columns to display the values of any indicator in the data base, such as: date, market, weight, volatility, etc . . .

The table can be searched and sorted with respect to the values in any column.

1.2 Selection

A list of securities may be selected from a domain, according to a predetermined set of user's specified criteria. Preferably, the portfolio data base is used as domain and a selection menu 16 is available to the user for definying the preferred selection.

The user may create a list of target securities using standard filters for security selection.

The security selection panel or menu 16 is presented to the user so that basic, fundamental, quantitative and technical data may be selected.

It is possible to define constrains on all the available indicators:

basic; for instance: type, market, sector, currency, nationality;

quantitative; such as: mean return, volatility, correlation, absolute and index-relative performance;

technical; such as: long-term trend, short term momentum, noise;

quantitative (second selection); such as: price/earning, price/book value, dividend.

Numerical constrains are defined in a graphical way, as shown in FIG. 2, and may be quantitative, for instance a volatility of no more than 2.5%, or qualitative, for instance a price/earning low or very low; where for instance “very low” means the the lowest quartile of the values in the used domain and “low” means the quartile before the lowest.

Qualitative values are automatically computed with respect to the securities in the used domain.

The resulting selection is present as a browser, a table or a chart 18.

As a matter of fact, all the available information about a specific security may be displayed in a specific window. As many security display windows can be opened at the same time as needed.

Each of the displays is fully configurable to include only the information or indicators relevant for a current task.

1.3 Editor

The portfolio data base can be manually built or expanded according to the user's need. In this respect an editor function is available.

Specific securities or groups are added to the data base or they are removed from the target portfolio under the user control.

Other portfolios may be used as a source for securities to add and two different portfolios may be merged.

The editor is able to import and export portfolios into and from a set of common formats, such as ASCII code, DBF or ODBC compatible sources.

The editor may even be used to create individual weighted or unweighted portfolios or indexed and recommendation lists.

1.4 Allocation

This module allows to optimize the securities allocation according to relative weights. It allows to define filters for personal and global asset allocation.

The user may choose on the video display 5 a set of indicators which, according to his strategy, must influence the relative weights of the securities in the current portfolio.

For instance, it might be desirable to allocate more on securities having high trend and low volatility or allocate more on securities having low price/earnings and low price/book value. A dynamic, balanced or conservative strategy may be applicable on any portfolio, country or sector selection just according to the investor's individual risk profile.

A relative priority matrix can be defined for a chosen indicator; for instance: high trend is worth 60% and low volatility is worth 40%.

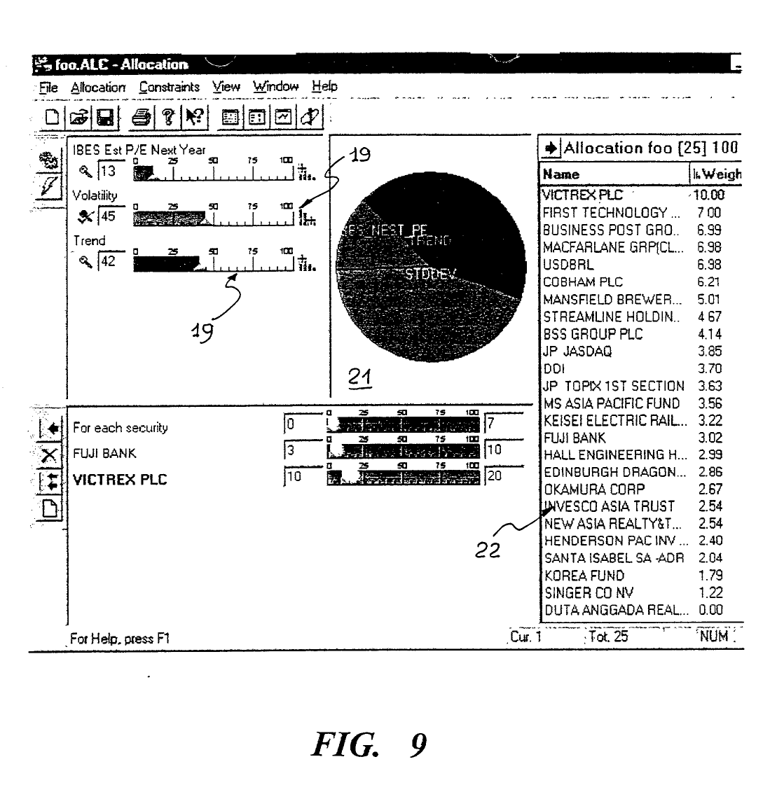

The weighting is displayed and defined by means of a very intuitive graphical interface 19, as shown in FIG. 9.

The selected allocation is quickly computed and an optimized portfolio allocation is presented on a menu 22 with respect to the combination of user's defined preferences.

User defined specific as well as generic constraints can be put on the allocation; for instance: no more than 3% on a certain security; between 2 and 2.5% on another security; no allocations smaller than 1%, and so on.

Constraints are easily added, modified or removed according to the present invention by means of the graphical interface.

The allocation algorithm picks up the user defined selection by means of a non-linear optimization procedure as will be explained in greater details hereinafter.

1.5 Analysis

The data base portfolio may be deeply analyzed through a specific module.

The analysis module computes the average of the portfolio combining the historical quotes of the securities while taking into account the portfolio allocations.

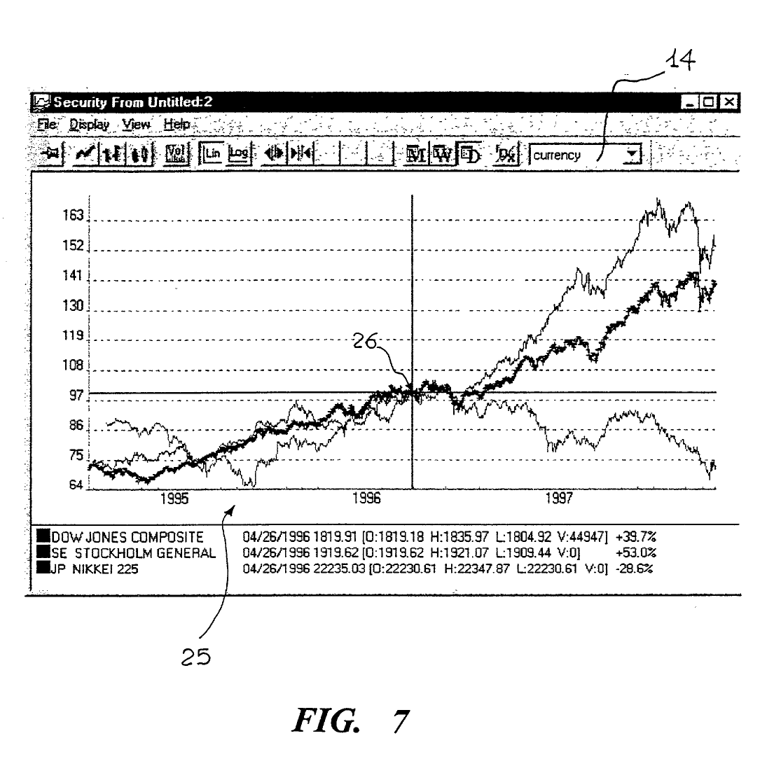

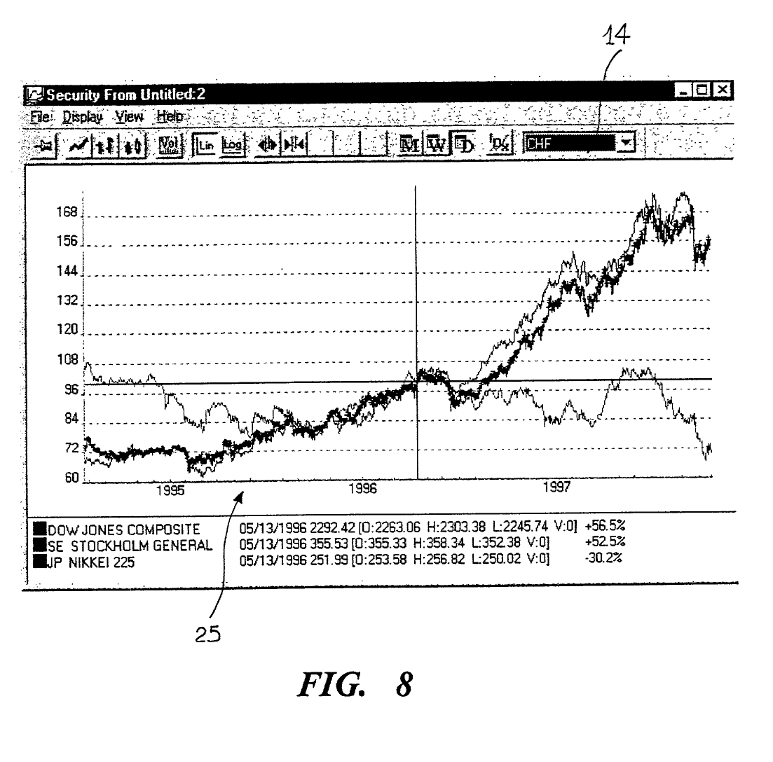

The resulting index is presented in a chart 25, as shown in FIG. 7. Such a chart can be graphically compared with any other security in the data base as shown in FIG. 8.

The indicators value of the portfolio index are also computed and are presented in a configurable table. The user can quickly navigate through a set of graphical views of the portfolio under consideration.

Pie charts, scatter diagrams or heat maps may be presented on the video display by defining the indicators to focus on.

1.6 Comparison

A comparison module allows to compare and match any set of portfolio data.

The user indicates a reference portfolio and a number of actual portfolios to be compared. The comparison module computes the buy/sell actions needed to transform each of the portfolios into the reference and the implied turnover.

The actions may be filtered and presented in a fully customized way.

The comparison allows to analyze the differences among the portfolios under consideration with a powerful set of display tools, such as multiple synchronized pie charts, multiple scanner diagrams, etc . . .

The comparison computes the average of all the portfolios under analysis combining the historical quotes of the securities and taking into account the portfolio allocations. The resulting indexes are presented in a single rescaled graph.

The indicators values of the indexes are computed and displayed in a customizable comparison table, as shown in Figure.

Hereinafter we will newly take in consideration the previous options to more deeply analyze the features of each program module.

2.1 Seletion: Fast Browsing of Market Data

Feature

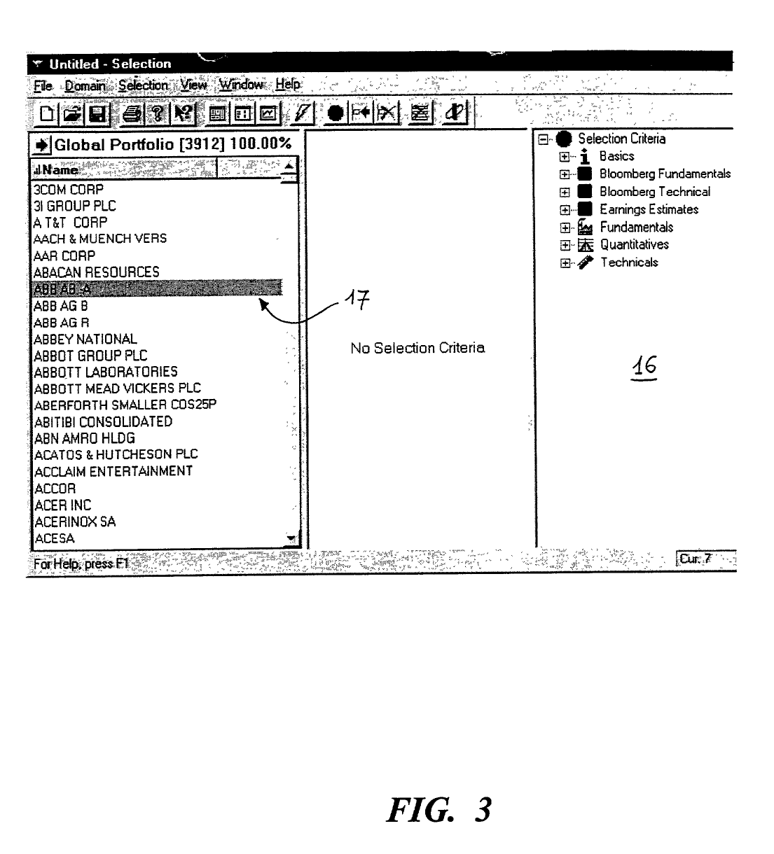

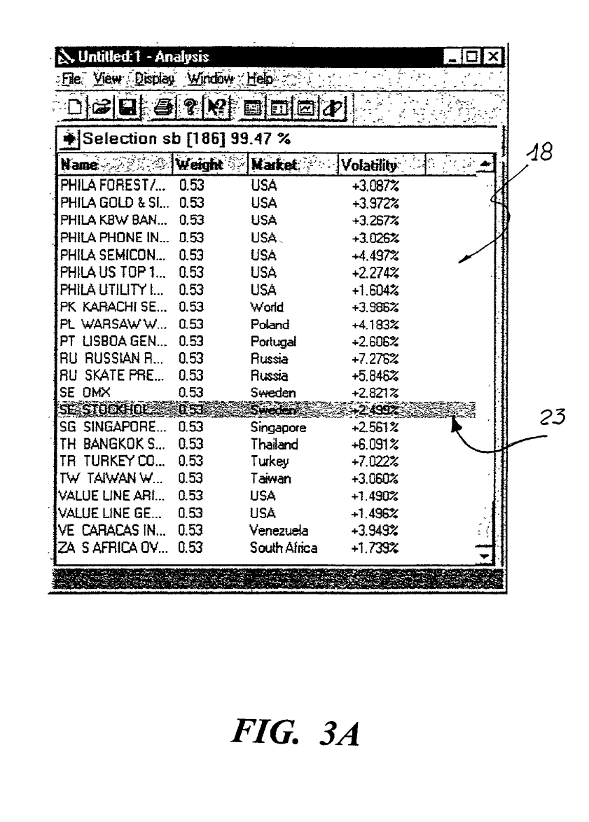

With specific reference to the example shown in FIG. 3A, the program presents to the user a selection panel 16 for displaying information and data and for allowing to the user to define data selection criteria.

For each portfolio display, there is a current security, whose name is highlighted, for instance the security indicated with 17 in FIG. 3.

After a selection, a table 18 is presented in front of the user as shown in FIG. 3A.

For the current highlighted security 23 it is possible at any time to open two different types of windows with detailed information.

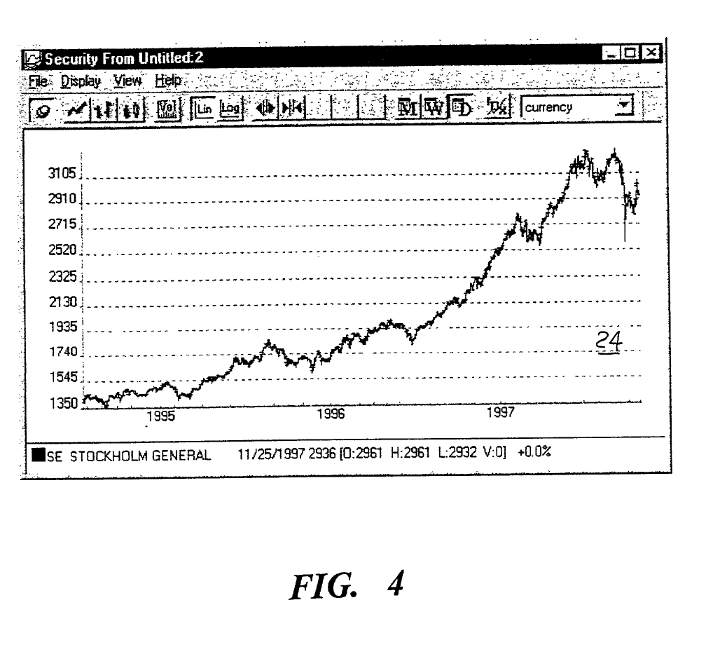

A) a graphical representation of the history of the security's market quotations, that is: a history chart 24 as shown in FIG. 4;

B) the display of all the updated information available in the data base, organized by category (basics, quantitative, technical, etc.); this is just a security display;

It is possible to open any number of such representations.

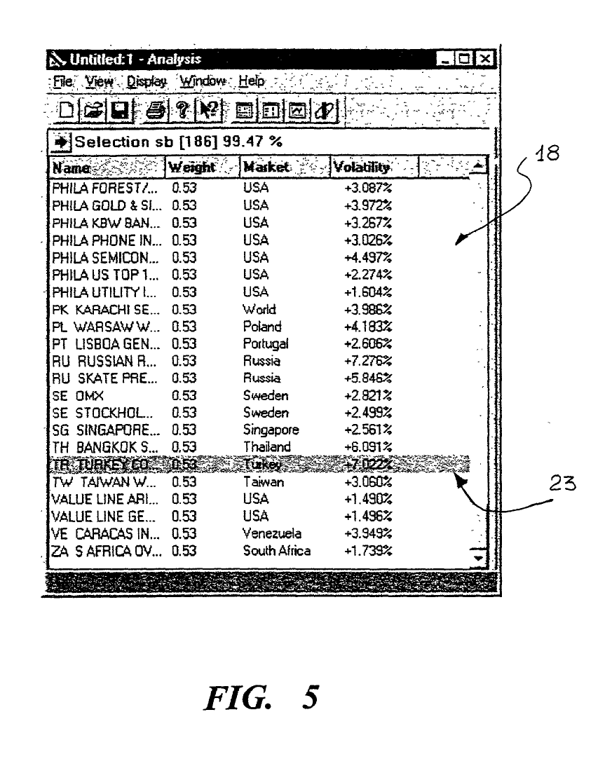

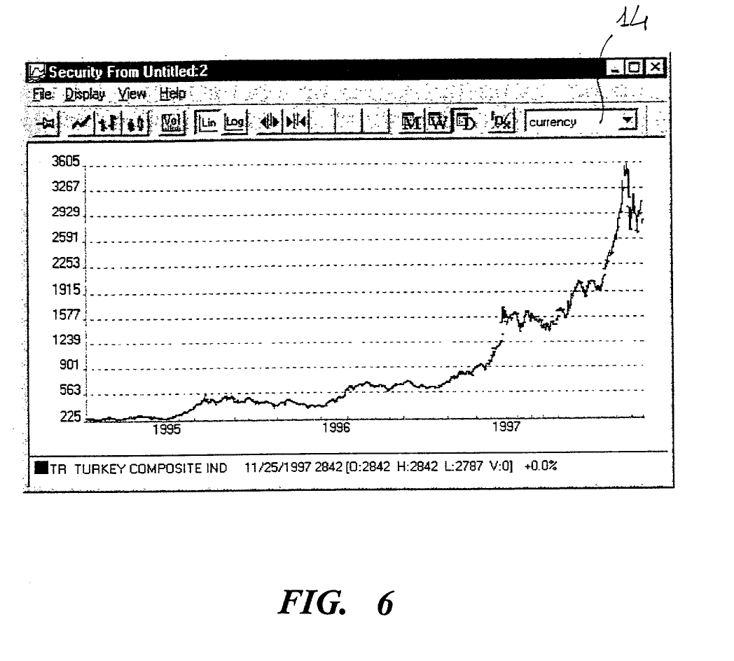

When the current highlighted security 23 is changed by the user, as shown in FIG. 5, the representations (graphs and/or tables) on the last opened windows are immediately updated to the newly focused security as shown in FIG. 6.

It is thus possible to quickly scan the securities in a portfolio flipping though detailed data and historical graphs.

Therefore, the exential features of the inventive method include the following steps:

presenting on the display means 5 a selection panel 16 or menu reporting a list or table 15 of data from the data base;

detecting a pointer of a user's data selection;

scanning the data base according to a mask or filter corresponding to the selection choosen by the user;

presenting on the display means 5 a view or history chart 24 showing to the user the variations versus time of the selected data, while maintaining a selected panel 18 as a side or background view;

refreshing immediately said view or history chart 24 at each different detected pointer 23 of the user's data selection.

The automatic refreshment of the history chart is such that for the user get the updated view in the same instant in which a new highlighted security 23 is detected.

2.2 Implementation

The implementation is based on the Document-View model of an architecture based on Microsoft Foundation Classes (MFC). In each application's document a pointer to the current security is defined. The portfolio display (browser) as well as the history chart and the security display are implemented as Views.

When a security name is selected in the portfolio display or browser, the current security in the application document is updated and all the views are notified with the standard Update CDocument method in MFC.

When notified of a current security change, both the history chart 24 and the security selected panel 18 ask to the data server 2 the information to be displayed. The data server 2 transmit the needed data in numerical format to the requiring views, which in turn compute the proper graphical representation of such views and update their displays on the screen.

3. Multiple Historical Series with Dynamic Rescaling

3.1 Feature

In a history chart it is possible to compare any number of securities histories, as shown in FIG. 7. This is achieved by dragging form a portfolio display or browser the name of the security into the screen area 25 of a displayed history chart. All the displayed histories are rescaled to a reference value, for instance 100, at the beginning (first day) of the displayed period.

When a point 26 in the chart is clicked, the rescale day is moved to the day in the history corresponding to the clicked point. The arrow keys allow to move the rescale day backward and forward on the time line. It is thus possible to evaluate the relative performances of all the securities displayed in a history chart over any specific period in the past, simply by clicking on the proper day. In the history graph legenda, the market data of all the displayed securities at the rescale day are displayed together with the performance of each of them since the rescale day.

When a different security is selected in the portfolio display, the original security in the history chart is substituted with the new one and the chart is rescaled to the last selected rescale day.

3.2 Implementation

The history chart view obtains from the data server 2 the history of each added security as soon as it is dragged into the chart screen area. The histories are stored in numerical format. The actual values to be displayed in graphical format are computed locally and by-need. When a new rescale day is selected, the value of all the histories is set to the reference value at the rescale day and each of them is transformed to keep unchanged the percentage variation of the value of each day with the value of the rescale day. After the transformation of the stored histories, a new graphical representation is computed and the display is updated.

This feature allows a plurality of different information data to be selected one after the other through said selected panel 18 and a corresponding plurality of history charts to be shown on said display means with the same time base and in an overlapping format, as clearly shown in FIG. 7.

4. Fast Analysis of Security History Series Through Technical Indicators

4.1 Feature

A studio module is a tool designed for the analysis of security history series through technical indicators such as return, average return, standard deviation, maximum draw-down, maximum recovery period and correlation to a benchmark.

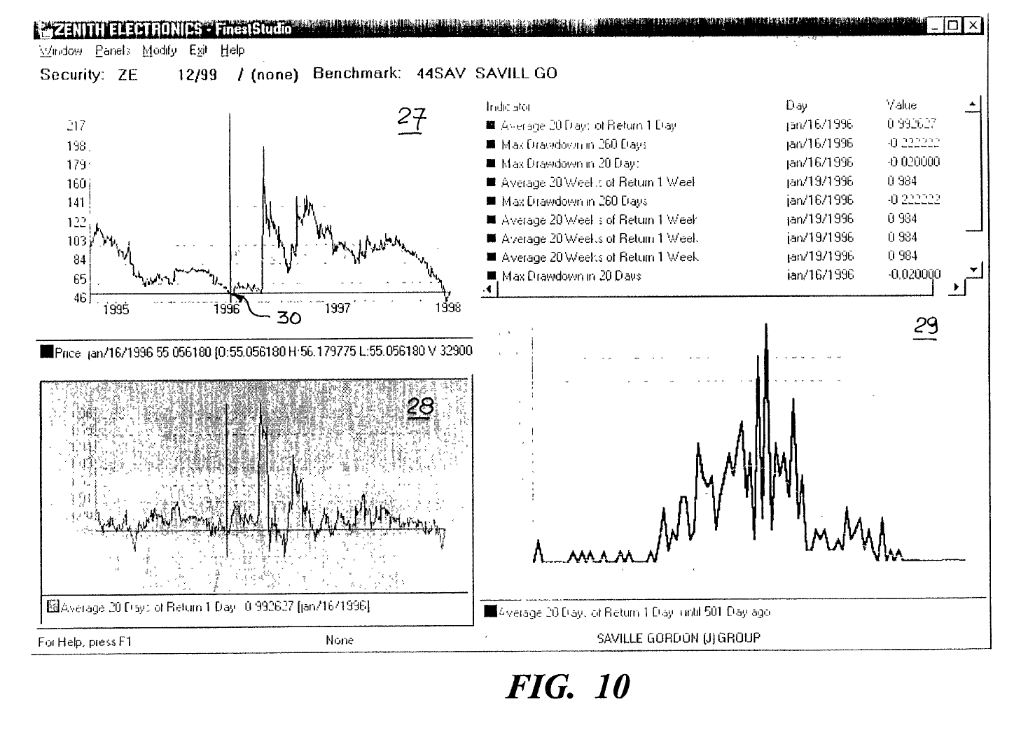

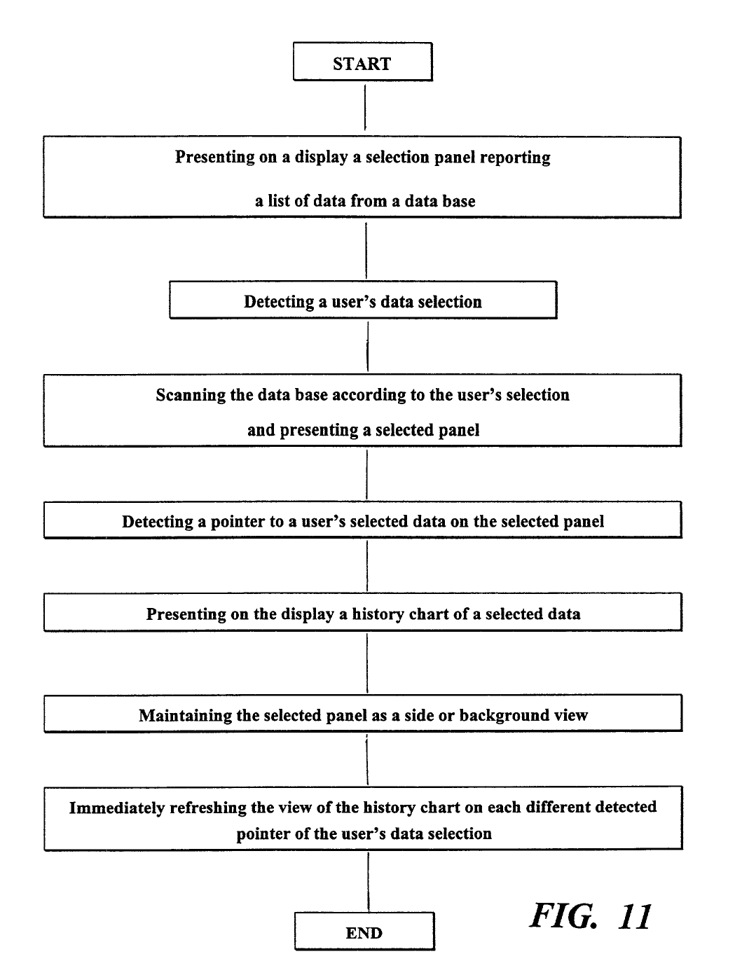

This module allows to display simultaneously a number of charts in a dynamic multiple splitter windows environment, as shown in FIG. 10. The available charts are the security price chart 27, indicators history charts 28 and indicators distribution charts 29.

Synchronize Function

4.1.1 Feature

The Synchronize Function is intended to help the user to match a specific time position over the different charts. A task such as finding out what happened to say-correlation when price had a specific value is accomplished just by moving the cursor to the selected chart time point 30 and asking for or clicking a button for a function “synchronize”. This causes all the other charts time scales to be sized accordingly to the leading chart and all cursors to jump to the same time position, so that the related indicators values are displayed.

As long as the current charts 27 is focused, the cursors is “synchronized” to the current chart so that moving it up or down the time scale causes all the other charts to move accordingly. Synchronized distribution charts automatically display distributions of values up to the day specified.

This feature makes easy to follow the historical development of a security price series and to analyze the relationship between different technical indicators.

4.2 Implementation

When the Synchronize Function is invoked, the current history chart (“leader”) starts notifying the other charts (via Windows messaging) all the information needed for synchronization:

the “time span” (the time interval spanned by the displayed data);

the “granularity” (flagging if daily, weekly or monthly data are displayed);

the “synchronize date” (the date leader's cursor is currently selecting).

Other history charts are then redrawn according to these synchronize information.

Setting the cursors according to the chart leader date causes the related value to be displayed. Distribution charts are recalculated on the fly after discarding the data referring to dates following the synchronization date.

As the leader's state changes the notification process keeps all charts synchronized.

The notification process stops when the “synchronize” button is clicked again or when the leader loses the focus.

5. Easy Currency Conversion of Historical Series

5.1 Feature

In the history chart, the “natural” currency of the displayed security is shown. The user can select, through a box 14, a different currency in the set of the currencies in the data base. The displayed history is transformed into the new currency taking into account the historical fluctuations of the exchange rate between the original currency and the new one, as shown in FIG. 8.

When multiple histories are displayed, all of them are converted from their original currency to the selected one. This allow to visually compare the performance of a set of international securities when the mutual ratios among the involved currencies is taken into account. When the currency is reset by the user, all the displayed histories return to their original currency.

5.2 Implementation

The data server 2 accepts two kind of queries for the history of a security: a plain one, and a currency-adjusted one.

When a currency-adjusted query is sent by an application, the server loads from the data base the historical data of the security and the history of the exchange rate between the “natural” currency of the security and the currency specified in the query. When the specific exchange rate is not available in the data base, it is computed by combining the historical exchange rate between each of the currencies and the US dollar.

The system data base contains a limited set of direct historical exchange rates and the historical exchange rates of all the considered currencies and the US dollar.

Each value in the security history is then multiplied by the corresponding value in the exchange rate history. The resulting converted history is thus transmitted to the requiring application.

When a specific currency is selected by the user, the history chart view issues a currency-adjusted query to the server 2 for each displayed security history and specifies for all of them the selected currency. The answers, are locally stored in numerical format, are rescaled according to the current rescale day and are displayed in graphical format on the screen.

6. Allocation by Ranking

6.1 Feature

As previously mentioned, with the allocation module it is possible to optimize the allocation of a portfolio. The optimization is performed according to a set of criteria interactively defined by the user. Any numerical dimension on which the securities in the portfolio can have a value can be used as an allocation criteria.

The user can thus select the allocation criteria among the numerical parameters available for the securities in the database. The user can also weight the selected criteria by graphically manipulating a set of cursors 19 which are presented on the screen as shown in FIG. 9 and corresponding also to a pie chart 21. There is one cursor for each criteria.

Weight of criteria is expressed in percentage.

The user interface includes a set of tools for balancing the weights according to the user's preferences. When the weight of a criteria is manipulated with the interface, the weights of the other criteria are adjusted in real-time to keep their total sum to 100, while respecting the ratios among them.

It is anyway possible to “freeze” the weights of a subset of the criteria. In this case the automatic adjustment modifies only the weights of the remaining criteria. Each criteria can be used on a direct (higher values are preferred) or an inverse (lower values are preferred) scale.

When the user asks for a new allocation, the system assigns a percentage of the portfolio to each security in the current list. Percentages are proportional to the scores of the securities with respect to the allocation criteria. The score of each security is computed as a combination of the values of the parameters in the data base used as allocation criteria. The security with a better compromise of values for the weighted criteria gets proportionally more than a security with a worse combined value.

With a specific interactive interface, the user can define a number of generic or specific constraints on the allocation. A generic constraint sets a lower and/or an upper limit to the allocation on any security in the portfolio (“no allocation more than 7%” and or “less than 5%”). A specific constraint sets an upper and/or lower limit to the allocation on a specific security in the portfolio. Inconsistency among constraints is detected and signaled in real-time. The computed allocation satisfies the defined constraints while optimally approximating the corresponding unconstrained allocation with the same criteria and criteria weighing.

In summary: the allocation module allows:

presenting on the display means a selection panel or menu reporting a list or table of data from said data base;

scanning said data base according to a mask or filter selected by the user to select a preferred set of data;

selecting an allocation criteria among a number of numerical parameters available for the preferred set of data;

weighting the selected criteria by graphically manipulating one or more cursors on the screen, one for each criteria;

automatically presenting on said display means the results of the weighted selection criteria at each different detected selection of said cursors.

6.2 Implementation

The user interface of the allocation module application is dynamically built on the set of criteria defined and weighted by the user. When a new criteria is added, the interface is restructured to host a new graphical object enabling the user to weight the criteria. When a new configuration of parameters has been defined, the application asks the server 2 for the values of the M parameters used as criteria for the N securities in the portfolio.

A N×M matrix is built and locally stored.

The securities values are thus cached in the application and it is not necessary to communicate with the server 2 if the set of the criteria is not changed. The computation of a new allocation is performed as follows:

The weights of the parameters are stored in a column vector of dimension M;

all the values in each column (same parameter) are normalized;

to each row (security) a score is assigned equal to the internal product of the row vector with the column vector of the parameters weights;

the scores are normalized;

the scores are proportionally transformed into allocation percentages.

Constraints are satisfied by solving a non-linear constrained optimization problem in which the constraints are directly used and the goal function to be minimized is defined as the sum for each security of the difference between the constrained and the unconstrained allocations divided by the normalized unconstrained allocation.

A possible implementation is the algorithm of search by feasible directions.(see: M. Bazaraa and C. Shetty, “Nonlinear programming: theory and algorithms” Wiley, New York 1979.)

The method and apparatus according to the present invention has the great advantage of allowing the managing of huge amounts of daily changing data and information which are transformed into image results helping the user in his decision process.

The method according to the invention may be considered as a very fast solving puzzle in which a huge amount of different pieces are correctly put together in order to provide a complete picture.

The method allows to work faster having all relevant investment information to take better investment decisions which may be based on the user preferred criteria.

This method allows to improve the investment results by taking optimized decisions according to security parameters.

The user may manage the risk by controlling portfolios and investment strategies.

What we claim is:

1. Method for elaborating and representing data analysis in a decision support system, the system comprising:
an electronic data base which is daily updated;
a data server managing said data base and comprising linking interfaces to allow on line and/or batch connections to external data suppliers or providers;
display means for displaying information and data and for allowing to the user to define data selection criteria;
the method including the following steps:
presenting on said display means a selection panel or menu reporting a list or table of data from said data base;
detecting a pointer of a user's data selection;
scanning said data base according to a mask or filter corresponding to the selection choosen by the user;
presenting on said display means a view or history chart showing to the user the variations versus time of the selected data, while maintaining a selected panel as a side or background view;
automatically and immediately refreshing said view or history chart at each different detected pointer of the user's data selection.

2. Method according to claim 1, wherein a plurality of different information data are selected one after the other through said selected panel and a corresponding plurality of history charts are shown on said display means with the same time base and in an overlapping format.

3. Method according to claim 2, wherein the different information data of the data base are quickly scanned by flipping through said historical charts.

4. Method according to claim 1, wherein the mask or filter selection is obtained by numerical constrains set by the user through a graphical interface.

5. Method according to claim 1, wherein the displayed history charts are rescaled to a reference value at the beginning of the displayed period of time.

6. Method according to claim 1, wherein the data base contains a securities portfolio.

7. Method according to claim 6, wherein said history chart represents the variations of the value of a selected security within a predetermined period of time and in a given currency.

8. Method according to claim 7, wherein the displayed history charts are transformed into a different currency taking into account the historical fluctuations of the exchange rate between the original currency and the new one.

9. Method according to claim 1, wherein the data are presented as table columns which are configured to display the values of any indicator in the data base.

10. Method for elaborating and representing data analysis in a decision support system, the system comprising:
an electronic data base which is daily updated;
a data server managing said data base and comprising linking interfaces to allow on line and/or batch connections to external data suppliers or providers;
display means for displaying information and data and for allowing to the user to define data selection criteria;
the method including the following steps:
presenting on said display means a selection panel or menu reporting a list or table of data from said data base;
scanning said data base according to a mask or filter corresponding to the selection choosen by the user to select a preferred set of data;
selecting an allocation criteria among a plurality of numerical parameters available for the preferred set of data;
weighting the selected criteria by graphically manipulating one or more cursors on the screen, one for each criteria;
automatically presenting on said display means the results of the weighted selection criteria at each different detected selection of said cursors.

11. Method according to claim 10, wherein when the weight of a criteria is manipulated through the graphic interface, the weights of the other criteria are adjusted in real-time to keep their total sum to one hundred, while respecting the ratios among them.

12. Method according to claim 10, wherein the data base contains a securities portfolio.

13. Method according to claim 12, wherein when the user selects a new allocation, the system assigns a percentage of the portfolio to each security in the selected list.

14. Method according to claim 13, wherein the percentages are proportional to scores of the securities with respect to the allocation criteria.

15. Method according to claim 14, wherein the score of each security is computed as a combination of the values of the parameters in the data base used as allocation criteria.

16. Method for elaborating and representing data analysis in a decision support system, the system comprising:
an electronic data base which is daily updated;
a data server managing said data base and comprising linking interfaces to allow on line and/or batch connections to external data suppliers or providers;
display means for displaying information and data and for allowing to the user to define data selection criteria;
the method including the following steps:
presenting on said display means a selection panel or menu reporting a list or table of data from said data base;
scanning said data base according to a mask or filter corresponding to the selection choosen by the user to select a preferred set of data;
detecting a pointer of a user's data selection;
presenting on said display means a leading history chart showing to the user the variations versus time of the selected data,
presenting other related charts as a side or background views;
detecting a preferred time point on the leading history chart by a user's cursor selection;
detecting a request of a syncronize function comand;
automatically refreshing the views or the related charts according to the new time scale defined by the above time point.

17. Method according to claim 16, wherein the detection of said time point and of the syncronize function activates an electronic message for the other charts including the following synchronization information:
a time interval spanned by the displayed data;
a flag corresponding to the daily, weekly or monthly base of the data to be displayed;
a synchronize date corresponding to the currently selected cursor position on the leader chart.

18. Method according to claim 16, wherein the leader chart is a security price chart and the other charts are at least an indicators history chart and and indicators distribution chart.

19. Apparatus for elaborating and representing data analysis in a decision support system, the system including:
an electronic data server including linking interfaces to allow on line and/or batch connections to external data suppliers or providers;
memory means inside said data server to store a data base which is daily updated;
display means for displaying information and data and for allowing to the user to define data selection criteria;
computing means for detecting a pointer of a user's data selection and scanning said data base in said memory means according to a mask or filter selected by the user;
image elaboration means for presenting on said display means a view or history chart showing to the user the variations versus time of the selected data, while maintaining the selection panel as a side or background view, and refreshing immediately said view or history chart at each different detected pointer of the user's data selection.
